(19) United States
(12) Patent Application Publication
(10) Pub. No.: US 2011/0067460 A1
(43) Pub. Date: Mar. 24, 2011

(54) LOCKABLE USB MEMORY DEVICE

(76) Inventors: Yasuyuki NIWA, Chiba-shi (JP); Toyoaki Makino, Kamakura-shi (JP); Koichi Kato, Yokohama-shi (JP); Hongxing Wang, Kawasaki-shi (JP); Hiroshi Yoshida, Kawasaki-shi (JP)

(21) Appl. No.: 12/888,968

(22) Filed: Sep. 23, 2010

(30) Foreign Application Priority Data
Sep. 24, 2009 (JP) 2009-219658

(51) Int. Cl. E05B 65/00; E05B 63/00; E05B 37/00; E05B 35/00

(52) U.S. Cl. 70/58; 70/263; 70/284

(57) ABSTRACT

According to one embodiment, a USB memory device includes a cylinder lock, a storage unit, and a control unit. The storage unit is capable of storing data. The control unit prohibits at least part of access to the storage unit from an outside when the cylinder lock is locked.

### CROSS-REFERENCE TO RELATED APPLICATIONS

This application is based upon and claims the benefit of priority from Japanese Patent Application No. 2009-219658, filed Sep. 24, 2009; the entire contents of which are incorporated herein by reference.

### FIELD

Embodiments described herein relate generally to a lockable USB memory device.

### BACKGROUND

Recently, a Universal Serial Bus (USB) memory device in which a flash memory is used is actively utilized as a removable recording medium used in a personal computer (PC) and the like.

Conventionally, in order to maintain the confidentiality of data recorded in the USB memory device, an electronic key is used such that input of a password is required in reading the data. For example, such keys are disclosed in Jap. Pat. Appln. KOKAI Publication Nos. 2001-051904, 2003-296196, 2008-040597, and 2008-123490.

For the use of such keys, it is possible that the number of characters (digits) of the password is increased in order to strengthen confidentiality of the data. However, when the number of characters (digits) of the password is excessively increased, a user may find it difficult to memorize such increased number of characters, which occasionally degrades usability.

### BRIEF DESCRIPTION OF THE DRAWINGS

FIG. 1 is an appearance diagram of a USB memory device according to a first embodiment;

FIG. 2 is a block diagram of the USB memory device according to the first embodiment;

FIG. 3 is a block diagram of a NAND flash memory according to the first embodiment;

FIG. 4 is a flowchart illustrating an operation of the USB memory device according to the first embodiment;

FIG. 5 is a conceptual view illustrating an operation of a USB memory device according to a second embodiment;

FIG. 6 and FIG. 7 are block diagrams illustrating a partial region of the USB memory device according to the second embodiment;

FIG. 8 is a flowchart illustrating an operation of the USB memory device according to the second embodiment;

FIG. 9 is a block diagram illustrating a partial region of the USB memory device according to a third embodiment;

FIG. 10 is a flowchart illustrating an operation of the USB memory device according to the third embodiment;

FIG. 11 and FIG. 12 respectively are a block diagram and a sectional view illustrating a partial region of a USB memory device according to a fourth embodiment;

FIG. 13 is a flowchart illustrating an operation of the USB memory device according to the fourth embodiment;

FIG. 14 and FIG. 15 are flowcharts illustrating an operation of a USB memory device according to a modification of the fourth embodiment;

FIG. 16 is an appearance diagram of a dimple key according to a fifth embodiment;

FIGS. 17 to 20 are appearance diagrams of the USB memory device according to the fifth embodiment;

FIG. 21 is a conceptual view illustrating an operation of the USB memory device according to the fifth embodiment; and

FIG. 22 is a flowchart illustrating an operation of a USB memory device according to a sixth embodiment.

### DETAILED DESCRIPTION

In general, according to one embodiment, a USB memory device includes: a cylinder-lock; a storage unit; and a control unit. The storage unit is capable of storing data. The control unit prohibits at least a part of access to the storage unit from an outside when the cylinder-lock is locked.

### First Embodiment

A USB memory device according to a first embodiment will be described below.

<Configuration of USB Memory Device>

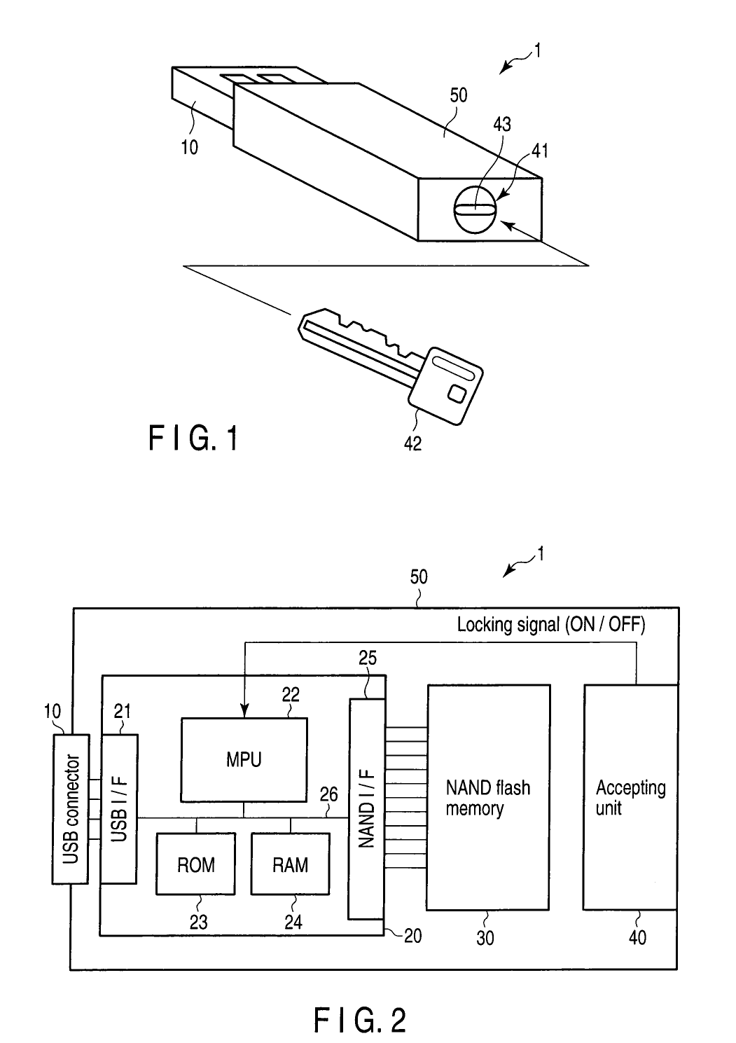

FIG. 1 and FIG. 2 are an appearance diagram of the USB memory device and a block diagram illustrating the inner configuration of the USB memory device of the first embodiment, respectively. As illustrated in FIG. 1 and FIG. 2, a USB memory device 1 basically includes a USB connector 10, a control unit 20, a NAND flash memory 30, an accepting unit 40, and a package 50 in which the units are packaged.

<<USB Connector 10>>

The USB connector 10 functions as a connection terminal to external host devices (not illustrated). Examples of the host device include a personal computer (PC), a digital camera, and a cellular phone. The USB connector 10 is connected to a USB terminal of the host device through a USB. An example in which the host device is a PC will be described below.

<<Control Unit 20>>

As illustrated in FIG. 2, the control unit 20 controls data transmission and reception between the USB connector 10 and the NAND flash memory 30. The control unit 20 includes a USB interface (I/F) 21, an MPU 22, a ROM 23, a RAM 24, a NAND interface (I/F) 25, and an internal bus 26, which are formed on, for example, the same semiconductor substrate.

The USB interface 21 controls communication with the host device. That is, the USB interface 21 receives data and a command, which are provided from the host device through the USB connector 10. For example, the data and the command are described in conformity with an SCSI (Small Computer System Interface) standard format. The USB interface 21 outputs the data read from the NAND flash memory 30 to the host device through the USB connector 10 according to the SCSI standard format.

The MPU 22 processes the command received from the host device and the data received from the NAND flash memory 30 using the ROM 23, the RAM 24, and the like. The MPU 22 performs authentication processing between the USB memory device 1 and the host device when the USB memory device 1 is connected to the host device. The MPU 22 permits or prohibits access to the USB memory device 1 from the host device based on a locking signal provided from the accepting unit 40 described later. The detailed description is made later on this point.

The ROM 23 retains the data and a program, which are necessary for the processing of the MPU 22. The RAM 24 functions as a work region in the processing of the MPU 22. For example, the RAM 24 is a volatile semiconductor memory such as a DRAM.

The NAND interface 25 controls the communication with the NAND flash memory 30. That is, the NAND interface 25 is connected to the NAND flash memory 30 through plural data lines. The NAND interface 25 transfers the command and data, received by the USB interface 21, to the NAND flash memory 30 and transfers the data read from the NAND flash memory 30 to the USB interface 21, in accordance with the command from the MPU 22.

<<Accepting Unit 40>>

As illustrated in FIG. 2, the accepting unit 40 accepts a permission (unlocking)/prohibition (locking) command of access to the USB memory device 1 using a physical mechanism. A cylinder type lock can be cited as an example of the physical mechanism. That is, as illustrated in FIG. 1, the accepting unit 40 includes a cylinder 41 functioning as a cylinder-lock, and the cylinder 41 includes a keyhole 43 in which a cylinder key 42 is inserted. In the cylinder-lock of the accepting unit 40, the cylinder key 42 is inserted in the keyhole 43 and rotated, thereby unlocking the cylinder-lock. The accepting unit 40 supplies information as to whether the cylinder-lock is unlocked, as the locking signal to the MPU 22 of the control unit 20. For example, the locking signal becomes “1 (high level)” when the cylinder-lock is unlocked, and the locking signal becomes “0 (low level)” when the cylinder-lock is locked.

<<NAND Flash Memory 30>>

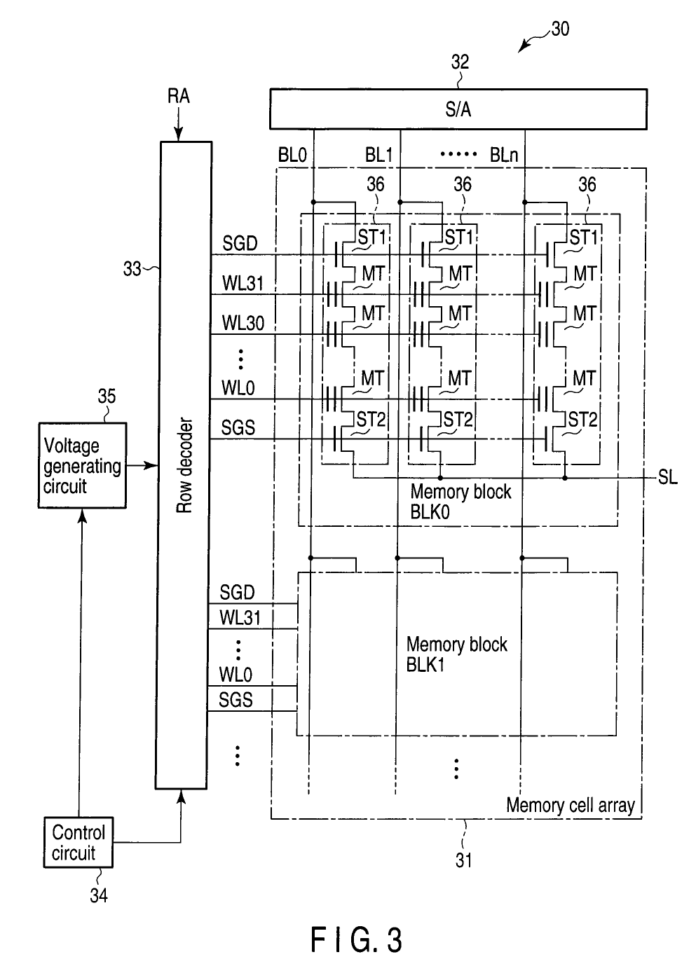

As illustrated in FIG. 2, the NAND flash memory 30 reads and outputs data in accordance with a read command provided from the control unit 20. Further, the NAND flash memory 30 records data in accordance with a write command from the control unit 20. An internal configuration of the NAND flash memory 30 will be described with reference to FIG. 3. FIG. 3 is a block diagram of an example of the NAND flash memory 30.

As illustrated in FIG. 3, the NAND flash memory 30 includes a memory cell array 31, a sense amplifier 32, a row decoder 33, a control circuit 34, and a voltage generating circuit 35.

First the memory cell array 30 will be described. It is assumed that the memory cell array 30 includes plural ((N+1), N is a natural number) memory blocks BLK0 to BLKN. Hereinafter the memory blocks BLK0 to BLKN are simply referred to as memory block BLK unless the memory blocks BLK0 to BLKN are distinguished from one another. Only one memory block BLK may be provided. Each memory block BLK includes (n+1) ((n+1) is a natural number) NAND strings 36.

At this point, for example, each NAND string 36 includes 32 memory cell transistors MT and selection transistors ST1 and ST2. The number of memory cell transistors MT is not limited to 32. Alternatively, for example, 8, 16, 64 memory cell transistors MT may be provided. The memory cell transistor MT has a stacked gate structure, and the stacked gate structure includes a charge accumulation layer (such as floating gate) that is formed on the semiconductor substrate with a gate insulating film interposed therebetween and a control gate that is formed on the charge accumulation layer with an intergate insulating film interposed therebetween. Each of a source and a drain is shared by the adjacent memory cell transistors MT. Current passes of the memory cell transistors MT are disposed between the selection transistors ST1 and ST2 so as to be series-connected. A drain on one end side of the series-connected memory cell transistors MT is connected to a source of the selection transistor ST1, and a source on the other end side is connected to a drain of the selection transistor ST2.

In each memory block BLK, the control gates of the memory cell transistors MT located on the same row are commonly connected to one of word lines WL0 to WL31, and the gates of the selection transistors ST1 and ST2 located on the same row are commonly connected to the selection gate lines SGD and SGS, respectively. For the sake of convenience, hereinafter occasionally the word lines WL0 to WL31 are simply referred to as word line WL. The sources of the selection transistors ST2 are commonly connected to the source line SL.

In the memory cell array 31 having the above-described configuration, the drains of the selection transistors ST1 in the NAND strings 36 located on the same column are commonly connected to one of bit lines BL0 to BLn. Occasionally the bit lines BL0 to BLn are simply referred to as bit line BL. That is, the bit line BL commonly connects the NAND strings 36 among the plural memory blocks BLK. On the other hand, the word line WL and the selection gate lines SGD and SGS commonly connect the NAND strings 36 in the same memory block BLK. The NAND strings 36 included in the memory cell array 31 are commonly connected to the same source line SL.

The data is collectively written in the plural memory cell transistors MT connected to the same word line WL, and the unit is called a page. The data is collectively erased in the NAND strings 36 located in the same memory block BLK. That is, the memory block BLK is an erasing unit.

In reading the data, the sense amplifier 32 senses and amplifies the data read onto the bit line BL from the memory cell transistor MT. The amplified data is output to the NAND interface 25 of the control unit 20. In writing the data, the sense amplifier 32 transfers the write data provided from the NAND interface 25 to the bit line BL, and the sense amplifier 32 writes the write data into the memory cell transistor MT.

During the data write operation, the data read operation, and the data erasing operation, the row decoder 33 selects the selection gate lines SGD and SGS and the word line WL connected to one of the memory blocks BLK to apply a voltage to the selection gate lines SGD and SGS and word line WL based on a row address RA provided from the NAND interface 25.

The voltage generating circuit 35 generates the voltages to write, read, and erase the data. The voltage generating circuit 35 supplies the generated voltages to the row decoder 33.

The control circuit 34 controls the whole operation of the NAND flash memory 30 in accordance with the command provided from the NAND interface 25.

<Operation of USB Memory Device>

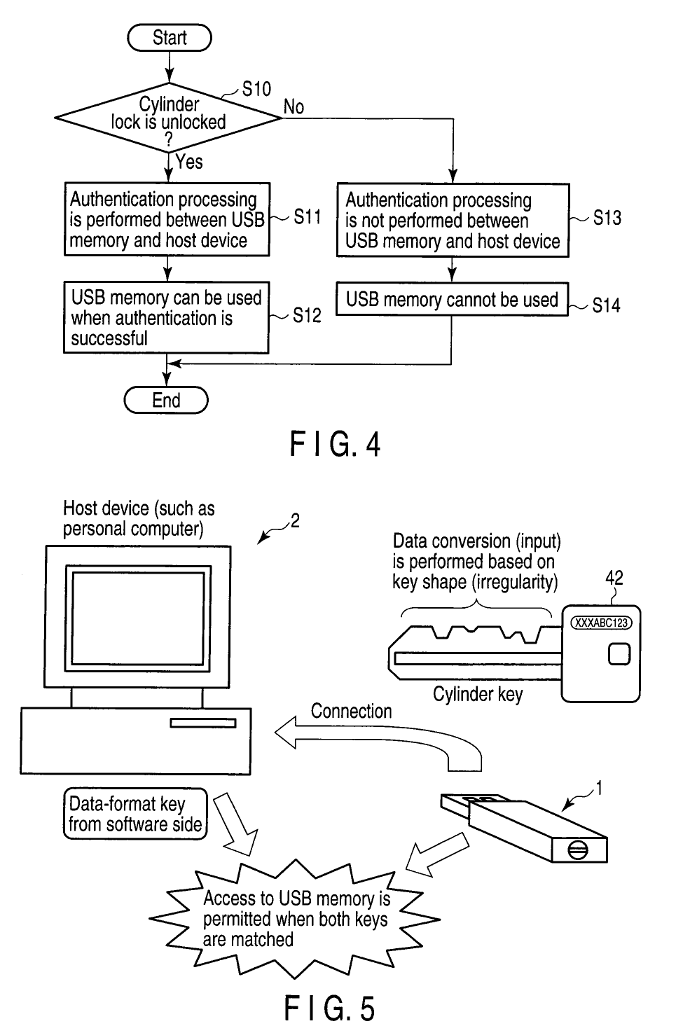

The operation of the USB memory device 1, particularly the operation in connecting the USB memory device 1 to the host device to start the use of the USB memory device will be described below. FIG. 4 is a flowchart of the operation of the USB memory device 1 and illustrates, for example, processing of the MPU 22 after the USB memory device 1 is connected to the host device.

When the USB memory device 1 is connected to the host device, the MPU 22 confirms whether the cylinder-lock is unlocked. This can be confirmed by the locking signal provided from the accepting unit 40.

When the cylinder-lock is unlocked (YES in Step S10), the MPU 22 performs authentication processing between the USB memory device 1 and the host device (Step S11). When the authentication processing is successful, the USB memory device 1 can be used (Step S12). That is, the host device can access the USB memory device 1.

On the other hand, when the cylinder-lock is locked (NO in Step S10), the MPU 22 does not perform the authentication processing (Step S13). As a result, the USB memory device 1 cannot be used (Step S14).

<Effect>

As described above, in the USB memory device of the first embodiment, the confidentiality of the data can be maintained while the degradation of the usability is prevented. The effect will be described below.

In dealing with the business of a company and the like, frequently the data is required in plural sites. An e-mail can be cited as an example of means for transmitting and receiving a small amount of data. However, for the use of the e-mail, a large amount of data is not added to the e-mail. When an e-mail is sent to a false mail address, or when the data is stolen from the e-mail, a third party may well gain access to the data.

The problem with the amount of data can substantially be solved by use of a storage medium such as the USB memory device. However, even if such storage medium is used, the problem in which an outsider can easily read the data, in the cases of theft or loss, still remains.

Therefore, there is a method for performing encryption in order to maintain the confidentiality of the data. The electronic key is widely used for the purpose of the encryption. That is, the host device such as a personal computer is required to input the password, and the host device is permitted to access the USB storage medium when the password is authenticated.

However, the data may well be analyzed by a malicious third party even if a password is set. Particularly, when a high-speed operation is realized by improvement of performance of the hardware, such as a personal computer or flash memory, the time taken for deciphering is shortened, thus there is a risk that a complicated password may be deciphered.

As to the countermeasure against password deciphering, it is generally possible to increase the number of characters (digits) of the password in order to strengthen the confidentiality of the data. In order to obtain such high confidentiality, the possibility that the password is easily deciphered can be reduced if the number of characters of the password is greatly increased. However, if the number of characters of the password is increased, the user will have trouble memorizing the password, which degrades the usability of the storage medium.

Another method is biometric authentication. In biometric authentication, disadvantageously only a specific individual can use the USB storage medium. Along with the use of fingerprint matching is the risk of a fingerprint being copied from the lost device.

On the other hand, in the USB memory device of the first embodiment, the USB memory device is locked by a physical mechanism such as a cylinder-lock. Accordingly, even if the storage medium body is stolen or lost, the data can hardly be removed unless the key is used. Additionally leakage of data cannot occur even if only the key, which is a counterpart of the cylinder-lock, is stolen or lost. The storage medium can be used among plural users only when the users have the key. Thus, the data can safely be carried when the simultaneous theft or loss of both the storage medium body and the key is avoided. As long password is unnecessary, a burden on an elderly person is reduced when the elderly person uses the USB memory device. Therefore, the confidentiality of the data can be maintained without a long password while not degrading the usability.

The following method can be cited as a possible method for utilizing the USB memory device of the first embodiment. For example, when the USB memory device 1 is sent by mail or home delivery, a main body of the USB memory device 1 and the key 42 are individually sent, so that leakage of the data can be prevented even if an accident occurs at some point.

When the data of high confidentiality is dealt with, it is necessary that a person who does not have an access right be prohibited access to the data to restrict the range of users. When the person who has the access right is changed, desirably the USB memory device corresponds flexibly to the change of the person who has the access right.

In the security function that employs encryption of a conventional password, even if a person does not have the access right, the person can access the data merely through knowledge of the password. Additionally, even if a person loses the access right, the person can access the data until the password is updated.

Therefore, in the method for utilizing the USB memory device 1 of the first embodiment, desirably the key 42 is provided to only the person who has the access right, and the key 42 is recovered at the same time as the person loses the access right, so that the USB memory device 1 can be managed while the range of users is restricted.

### Second Embodiment

A USB memory device according to a second embodiment will be described below. The second embodiment relates to use of an additional software key in the first embodiment. Only the point that is different from that of the first embodiment will be described below.

### Concept of Key of Second Embodiment

First, a concept of the key of the second embodiment will be described with reference to FIG. 5. FIG. 5 is a conceptual view illustrating an operation of the USB memory device of the second embodiment.

As illustrated in FIG. 5, the USB memory device 1 converts a shape (for example, irregularity) of the key 42 into data. After the USB memory device 1 is connected to the host device 2, the host device 2 encourages the user to input the password, that is, the electronic key from a software side.

Access to the USB memory device 1 is permitted when the data obtained from the key 42 is matched with the data (key) input from the software side and when the cylinder-lock is unlocked.

<Configuration of Accepting Unit 40>

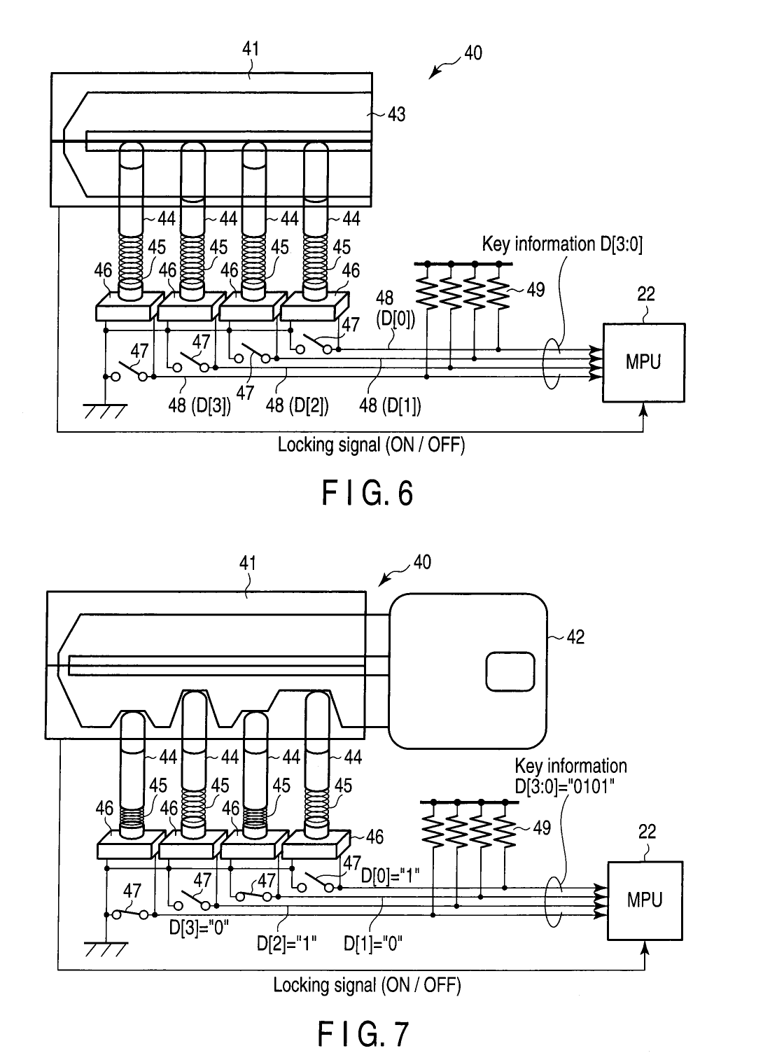

FIG. 6 is a block diagram illustrating a configuration of the accepting unit 40 in the USB memory device 1 of the second embodiment.

As illustrated in FIG. 6, the accepting unit 40 includes the cylinder 41, the keyhole 43, a tumbler 44, and a spring 45, which form the cylinder-lock. The accepting unit 40 also includes a sensor 46, a switch 47, a signal line 48, and a resistor element 49.

The cylinder 41 includes an outer cylinder and an inner cylinder (not illustrated). The inner cylinder can be rotated in the outer cylinder to unlock the cylinder-lock by inserting the cylinder key (passkey) 42 in the keyhole 43.

The tumbler 44 is plural movable barriers that are provided in a boundary between the inner cylinder and the outer cylinder of the cylinder 41. One end of the tumbler 44 is located in the keyhole 43. When the cylinder key 42 is inserted in the keyhole 43, the tumbler 44 is moved according to a shape of a key tooth of the cylinder key 42. For the passkey, the tumbler 44 is aligned with a shear line (a contact surface between the inner cylinder and the outer cylinder), so that the inner cylinder of the cylinder 41 can be rotated.

The spring 45 is provided between the other end of each tumbler 44 and the sensor 46. The spring 45 transmits the motion of the tumbler 44 generated by inserting the cylinder key 42 to the sensor 46. There is no limitation to the spring 45 as long as the spring is an elastic body, and the spring 45 may be one that can transmit the motion of the tumbler 44 to the sensor 46.

The sensor 46 senses the motion of the tumbler 44 through the spring 45. When the tumbler 44 is pushed to a given degree or more by inserting the cylinder key 42, the switch 47 provided in each sensor 46 is turned on.

The switch 47 is put into the on state by the sensor 46, thereby grounding the signal line 48 provided in each switch 47.

The key information on “1” or “0” is transmitted to the MPU 22 through the signal line 48 according to the on/off state of the switch 47. That is, because the signal line 48 is grounded when the switch 47 is put into the on state, the key information becomes “0”. On the other hand, when the switch 47 is put into the off state, a potential at the signal line 48 depends on the resistor element 49 connected to each signal line 49, and the key information becomes “1”. In the example of FIG. 6, the key information is four bits because the four tumblers 44 are provided. Hereinafter the key information is referred to as D[3:0] and the bits of the key information are referred to as D[3] to D[0]. The number of bits of the key information is not limited to the four bits, and the number of bits may arbitrarily be determined depending on the number of tumblers 44.

FIG. 7 is a block diagram illustrating the configuration of the accepting unit 40 similarly to FIG. 6, and FIG. 7 illustrates a state in which the cylinder key 42 is inserted in the keyhole 43. As illustrated in FIG. 7, two of the four tumblers 44 are pushed by inserting the cylinder key 42, and the corresponding switches 47 are put into the on state. As a result, D[3]=D[1]=“0” is obtained, and the key information becomes D[3:0]=“0101”.

<Operation of USB Memory Device>

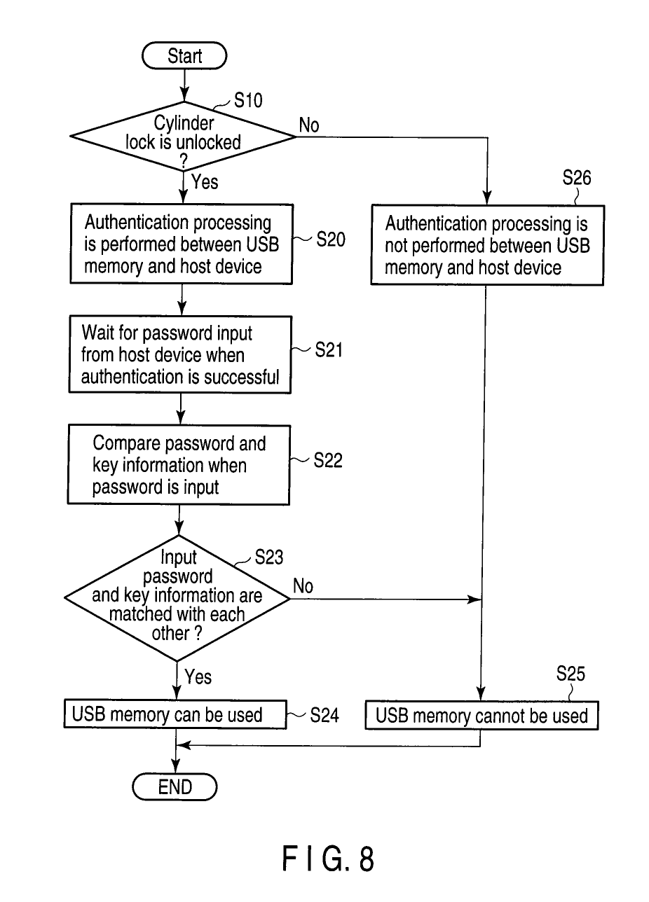

The operation of the USB memory device 1 of the second embodiment, particularly the operation in connecting the USB memory device 1 to the host device to start the use of the USB memory device 1 will be described below. FIG. 8 is a flowchart of the operation of the USB memory device 1 and illustrates, for example, the processing of the MPU 22 after the USB memory device 1 is connected to the host device.

When the USB memory device 1 is connected to the host device, the MPU 22 confirms whether the cylinder-lock is unlocked. When the cylinder-lock is unlocked (YES in Step S10), the MPU 22 performs the authentication processing between the USB memory device 1 and the host device (Step S20). However, complete authentication is not required, and the authentication may be performed only to accept the input of the password from the host device.

When the authentication processing is successful, the USB memory device 1 waits for the input of the password from the host device (Step S21). When the user inputs the password through the host device, the MPU 22 compares the password to the key information D[3:0] obtained from the cylinder key 42 (Step S22).

When the input password is matched with the key information (YES in Step S23), the MPU 22 permits the host device to access the NAND flash memory 30, and the USB memory device 1 can be used. That is, in the example of FIG. 7, because the key information is “0101”, the USB memory device 1 can be used when “0101” is input as the password from the host device. On the other hand, when the input password is not matched with the key information (NO in Step S23), the USB memory device 1 cannot be used (Step S25).

When the cylinder-lock is locked in Step S10 (NO in Step S10), because the MPU 22 does not perform the authentication processing (Step S26), the USB memory device 1 cannot be used, irrespective of the password (Step S25).

<Effect>

As described above, in the USB memory device of the second embodiment, the data confidentiality can be further improved in addition to the effect of the first embodiment.

That is, in the configuration of the second embodiment, the user can use the USB memory device 1 only when having not only the physical key 42 but also the electronic key (password) input from the host device. Accordingly, a risk of access to the data from the third party can further be reduced.

In the second embodiment, the shape of the cylinder key 42 is directly used as the key information. However, the data of the shape of the cylinder key 42 is further converted into data, and the further converted data may be used as the key information. At this point, although the key information is four bits in the example of FIG. 6 and FIG. 7, the key information may be subjected to the data conversion to obtain the key information, that is, the password of five bits or more. The data can be converted by plural methods, so that the user can select the password from plural options. Therefore, the password can be changed. In such cases, management software is separately prepared in the host device, and therefore the password may be stored in the RAM 24 of the USB memory device 1 or a system area of the NAND flash memory 30. When the user forgets the password, for example, the USB memory device 1 is formatted to completely erase recording contents, which allows the password to be reset.

The comparison processing in Step S22 of FIG. 8 may be performed by not the MPU 22 but the host device. For example, the MPU 22 transfers the key information read from the cylinder key 42 to the host device, and the host device compares the key information to the password. When the key information is matched with the password, the host device outputs a signal indicating that the key information is matched with the password to the USB memory device 1, and the MPU 22 that receives the signal enables the USB memory device 1 to be used.

### Third Embodiment

A USB memory device according to a third embodiment will be described below. The third embodiment relates to a method for encrypting the data in the first embodiment. Only the point that is different from that of the first embodiment will be described below.

<Configuration of Accepting Unit 40>

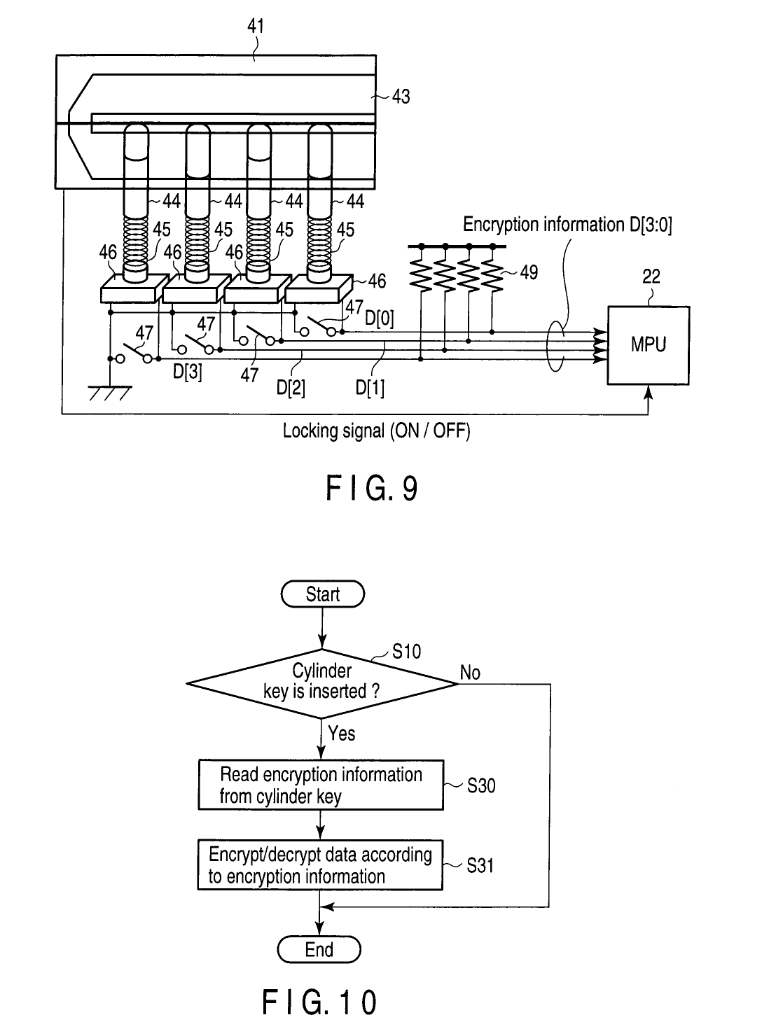

FIG. 9 is a block diagram illustrating a configuration of the accepting unit 40 in the USB memory device 1 of the third embodiment. As illustrated in FIG. 9, the configuration of the accepting unit 40 of the third embodiment is similar to that of the second embodiment of FIG. 6. The configuration of the accepting unit 40 differs from that of the second embodiment in that the signal transmitted through the signal line 48 is used as not the key information but the encryption information D[3:0]. The encryption information means information indicating an encryption method adopted for the data recorded in the USB memory device 1. The same method as the method for reading the key information in the second embodiment can be used as a method for reading the encryption information from the cylinder key 42.

<Operation of USB Memory Device>

The operation of the USB memory device 1 of the third embodiment, particularly the operation in determining the encryption method in the USB memory device 1 will be described below. FIG. 10 is a flowchart of the operation of the USB memory device 1.

As illustrated in FIG. 10, when the cylinder key 42 is inserted in the keyhole 43 (YES in Step S10), the accepting unit 40 reads the encryption information D[3:0] from the cylinder key 42 (Step S30). The MPU 22 encrypts and/or decrypts the write data and/or read data of the NAND flash memory 30 according to the read encryption information D[3:0] (Step S31). That is, the MPU 22 determines the encryption method to be used according to the read encryption information D[3:0].

On the other hand, when the cylinder key 42 is not inserted in the keyhole 43 (NO in Step S10), the MPU 22 does not encrypt and decrypt the data. That is, the user cannot decipher the encrypted data recorded in the NAND flash memory 30.

In the third embodiment, the processing illustrated in the flowchart of FIG. 4 can also be performed independently of the flowchart of FIG. 10.

<Effect>

As described above, in the USB memory device of the third embodiment, the confidentiality of the data can be improved further than that of the first embodiment.

In the configuration of the third embodiment, during the data recording, the MPU 22 encrypts the data provided from the host device and writes the encrypted data in the NAND flash memory 30. During the data reading, the MPU 22 decrypts the data read from the NAND flash memory 30 and outputs the decrypted data to the host device.

In performing the encryption and/or decryption, the encryption method is determined by the shape of the cylinder key 42. Accordingly, unauthorized access to the data from the third party can more effectively be prevented.

The encryption and/or decryption function may be possessed by not the MPU 22 but the host device. At this point, the MPU 22 transfers the encryption information read from the cylinder key 42 to the host device, and the host device encrypts and/or decrypts the data according to the encryption information.

The MPU 22 may perform the encryption in recording the data in the USB memory device 1, and the host device may perform the decryption in reading the data. At this point, the data can be deciphered only by the host device in which software capable of encrypting/decrypting the data according to the encryption method selected by the MPU 22 is installed. Desirably the encryption method adopted in the USB memory device 1 and/or the host device can be updated to the latest algorithm using, for example, dedicated software.

The processing of the flowchart of FIG. 10 may be performed after the determination that the cylinder-lock is unlocked is made in Step S10 (YES in Step S10) in the flowchart of FIG. 4, the processing of the flowchart of FIG. 10 may be performed after the authentication processing is successful (Step S12), or the processing of the flowchart of FIG. 10 may be performed independently of the flowchart of FIG. 4.

<Modification>

The third embodiment can be combined with the second embodiment. That is, the processing of FIG. 10 may be performed along with the processing of FIG. 8. At this point, the key information of the second embodiment may directly be used as the encryption information. For example, in the example of FIG. 7, both the key information and the encryption information become “0101”.

The value into which the data read from the shape of the cylinder key 42 is converted may be used as the key information and/or the encryption information. At this point, the value of the key information may differ from the value of the encryption information.

Further, different tumblers 44, springs 45, sensors 46, switches 47, and signal lines 48 may be provided in order to read the key information and to read the encryption information, respectively. At this point, for example, part of the key tooth of the cylinder key 42 may be read as the key information while another part of the key tooth may be read as the encryption information. The method for reading the key information or the encryption information from the cylinder key 42 and the method for converting the read data can appropriately be selected.

### Fourth Embodiment

A USB memory device according to a fourth embodiment will be described below. The fourth embodiment relates to a method for reading encryption information by an optical technique in the third embodiment. Only the point that is different from that of the third embodiment will be described below.

<Configuration of Accepting Unit 40>

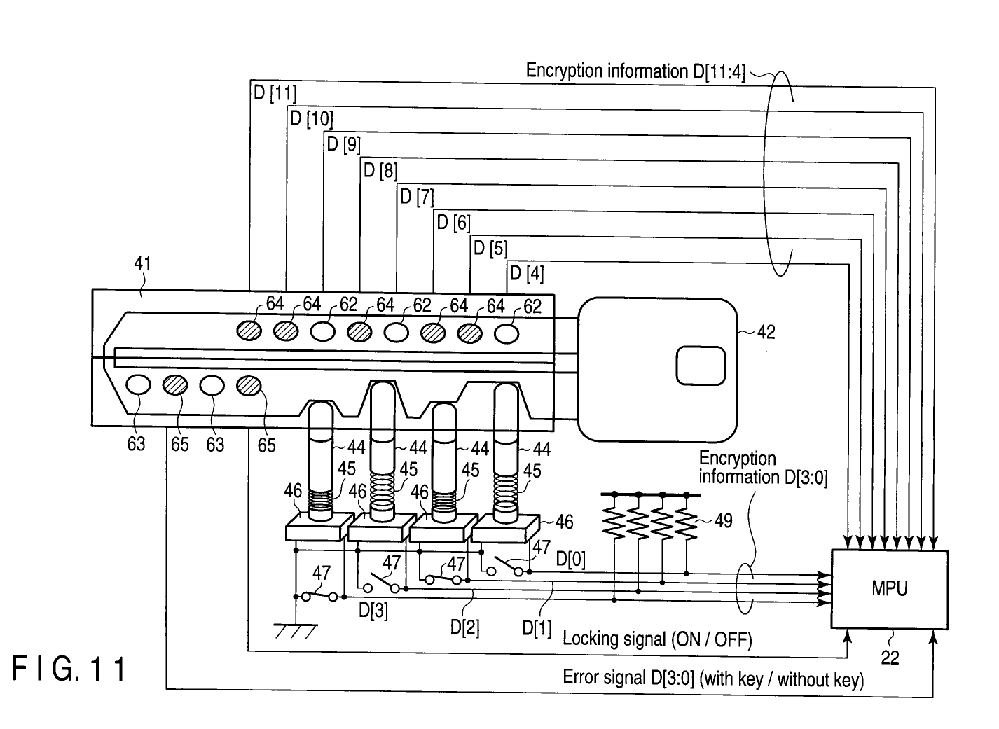

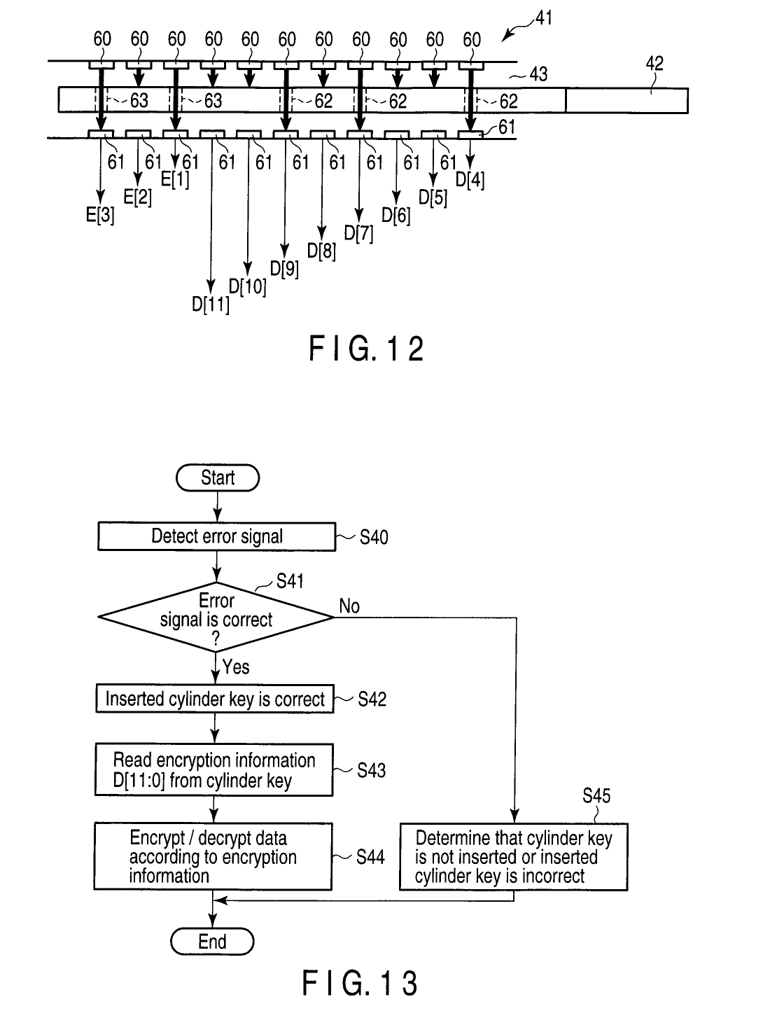

FIG. 11 and FIG. 12 are block diagrams illustrating a configuration of the accepting unit 40 in the USB memory device 1 of the fourth embodiment, and FIG. 11 and FIG. 12 illustrate a state in which the cylinder key 42 is inserted. FIG. 12 is a sectional view of the cylinder 41, particularly a state of a side surface in the keyhole.

The accepting unit 40 of the fourth embodiment further includes light emitting elements (for example, LED) 60 and light receiving elements (for example, phototransistor) 61 in the configuration of FIG. 9 of the third embodiment. In the keyhole 43, the light emitting elements 60 are disposed facing one surface of the cylinder key 42, and the light receiving elements 61 are disposed facing the other surface of the cylinder key 42. The light emitting element 60 and the light receiving element 61 are disposed facing each other in a one-on-one manner while the inserted cylinder key 42 is interposed therebetween.

Light emitted from each light emitting element 60 is received by the corresponding light receiving element 61, and the result is provided as encryption information D[11:4] and an error signal E[3:0] to the MPU 22. In the example of FIG. 11 and FIG. 12, there are 12 combinations of the light emitting elements 60 and the light receiving elements 61, and the signals from the light receiving elements 61 in the eight combinations become the encryption information D[11:4]. Accordingly, the encryption information includes a total of 12 bits; 4 bits provided from the tumbler 44 and 8 bits provided from the light receiving element 61.

The signals from the light receiving elements 61 in the remaining 4 combinations of the 12 combinations of the light emitting elements 60 and the light receiving elements 61 are provided as the error signal E[3:0] to the MPU 22. The error signal E[3:0] is information indicating whether the cylinder key 42 is inserted in the keyhole 43 and/or whether the inserted cylinder key 42 is correct.

The numbers of bits of the encryption information and the error signal are arbitrarily determined, and the number of combinations of the light emitting elements 60 and the light receiving elements 61 may be lower than 8 bits or more than 8 bits. The output signal becomes “0” when the light receiving element 61 receives the light output from the light emitting element 60, and the output signal becomes “1” when the light receiving element 61 does not receive the light.

The cylinder key 42 used in the fourth embodiment includes openings 62 and 63 and closed portions 64 and 65 in a surface thereof. The openings 62 and 63 and the closed portions 64 and 65 correspond to the 12 combinations of the light emitting elements 60 and the light receiving elements 61, respectively. In the combinations corresponding to the openings 62 and 63, the light receiving element 61 receives the light output from the light emitting element 60. In the combinations corresponding to the closed portions 64 and 65, the closed portions 64 and 65 block the light output from the light emitting element 60, and the light receiving element 61 does not receive the light. The openings 62 and the closed portions 64 correspond to the encryption information D[11:4], and the openings 63 and the closed portions 65 correspond to the error signal E[3:0].

In the example of FIG. 11, a white circle indicates the openings 62 and 63 and a black circle indicates the closed portions 64 and 65. Accordingly, encryption information D[11:4]=“11010110” and error signal E[3:0]=“0101” are obtained. Obviously the numbers of openings 62 and 63, closed portions 64 and 65, light emitting elements 60, and light receiving elements 61 can appropriately be selected.

<Operation of USB Memory Device>

The operation of the USB memory device 1 of the fourth embodiment, particularly the operation in determining the encryption method in the USB memory device 1 will be described below. FIG. 13 is a flowchart of the operation of the USB memory device 1.

As illustrated in FIG. 13, the accepting unit 40 reads the error signal E[3:0] from the cylinder key 42 (Step S40). The MPU 22 determines whether the read error signal E[3:0] is correct (Step S41). The accepting unit 40 retains the information on the correct cylinder key 42 in, for example, the ROM 23. It is assumed that the information is “0101”. When the cylinder key 42 of FIG. 11 is inserted, error signal E[3:0]=“0101” is obtained, and the error signal E[3:0] is matched with the information (YES in Step S41). Therefore, the MPU 22 determines that the cylinder key 42 is correct (Step S42).

Then the accepting unit 40 reads the encryption information D[11:0] from the cylinder key 42 (Step S43). The MPU 22 encrypts and/or decrypts the data according to the read encryption information (Step S44).

On the other hand, when the read error signal E[3:0] is incorrect (NO in Step S41), the MPU 22 determines that the cylinder key 42 is not inserted or the cylinder key 42 is an unauthorized key (Step S45). For example, the MPU 22 determines that the cylinder key 42 is not inserted when error signal E[3:0]=“0000” is obtained, and the MPU 22 determines that the cylinder key 42 is an unauthorized key when an error signal other than “0101” is obtained. Therefore, the MPU 22 does not perform the encryption and decryption of the data. That is, the user cannot decipher the encrypted data recorded in the NAND flash memory 30.

In the fourth embodiment, the processing illustrated in the flowchart of FIG. 4 can also be performed independently of the flowchart of FIG. 13.

<Effect>

As described above, in the fourth embodiment, the encryption information of the third embodiment can be read by the optical technique. At this point, the utilization of the openings 62 and the closed portions 64 provided in the surface of the cylinder key 42 can increase the amount of encryption information compared with the case in which only the key tooth is used as the encryption information. Therefore, the encryption information can be complicated, to further improve the confidentiality of the data.

Part of the information read from the cylinder key 42 by the optical technique is used to determine whether the cylinder key 42 is present or absent and/or whether the cylinder key 42 is correct or incorrect. Therefore, access to the USB memory device 1 with an unauthorized cylinder key 42 can be prevented.

In the fourth embodiment, all the bits of D[11:0] are used as the encryption information. Alternatively, part of the bits of D[11:0] may be used. The error signal need not be considered (the Steps S40 to S42 and S45 of FIG. 13 are eliminated). Even in this case, the encryption method can be selected from the cylinder key 42.

<First Modification>

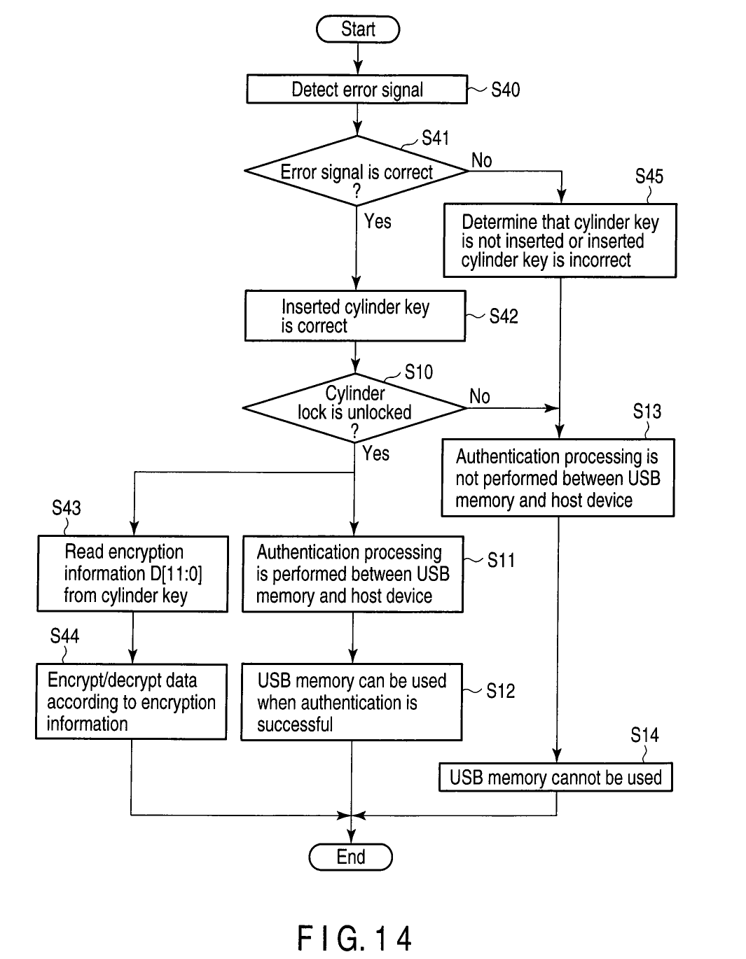

In the fourth embodiment, the encryption and/or decryption is performed based on the error signal by way of example. Alternatively, the error signal may be used as a reference as to whether access to the USB memory device 1 is permitted. FIG. 14 illustrates the processing of the case in which the error signal is used as the reference as to whether access to the USB memory device 1 is permitted. FIG. 14 is a flowchart illustrating processing of the accepting unit 40.

As illustrated in FIG. 14, the MPU 22 detects the error signal (Step S40). When the error signal is incorrect (NO in Step S41), the cylinder key 42 is not inserted or the inserted cylinder key 42 is an unauthorized key (Step S45). Therefore, the MPU 22 does not perform the authentication processing between the USB memory device 1 and the host device (Step S13). That is, the USB memory device 1 cannot be used (Step S14).

Even if the inserted cylinder key 42 is the correct key (YES in Step S41 and Step S42), the USB memory device 1 cannot be used (Steps S13 and S14) when the cylinder-lock is locked (NO in Step S10).

When the inserted cylinder key 42 is the correct key (YES in Step S41 and Step S42) and when the cylinder-lock is unlocked (YES in Step S10), the MPU 22 performs the authentication processing (Step S11). When the authentication is successful, the USB memory device 1 can be used. When the cylinder-lock is unlocked (YES in Step S10), the encryption information is read (Step S43). The processing in Step S43 may be performed after the processing in Step S42 or Step S12.

According to the method of the first modification, even if the cylinder-lock is unlocked by the unauthorized key, access to the USB memory device 1 can be prevented to further improve reliability of the confidentiality of the data.

<Second Modification>

The structure of FIG. 11 and FIG. 12 of the fourth embodiment can be applied to the second embodiment. That is, the encryption information of FIG. 11 and FIG. 12 may be used as the key information. Therefore, the amount of key information can be increased, and the password used to access the USB memory device 1 can be made more complicated.

<Third Modification>

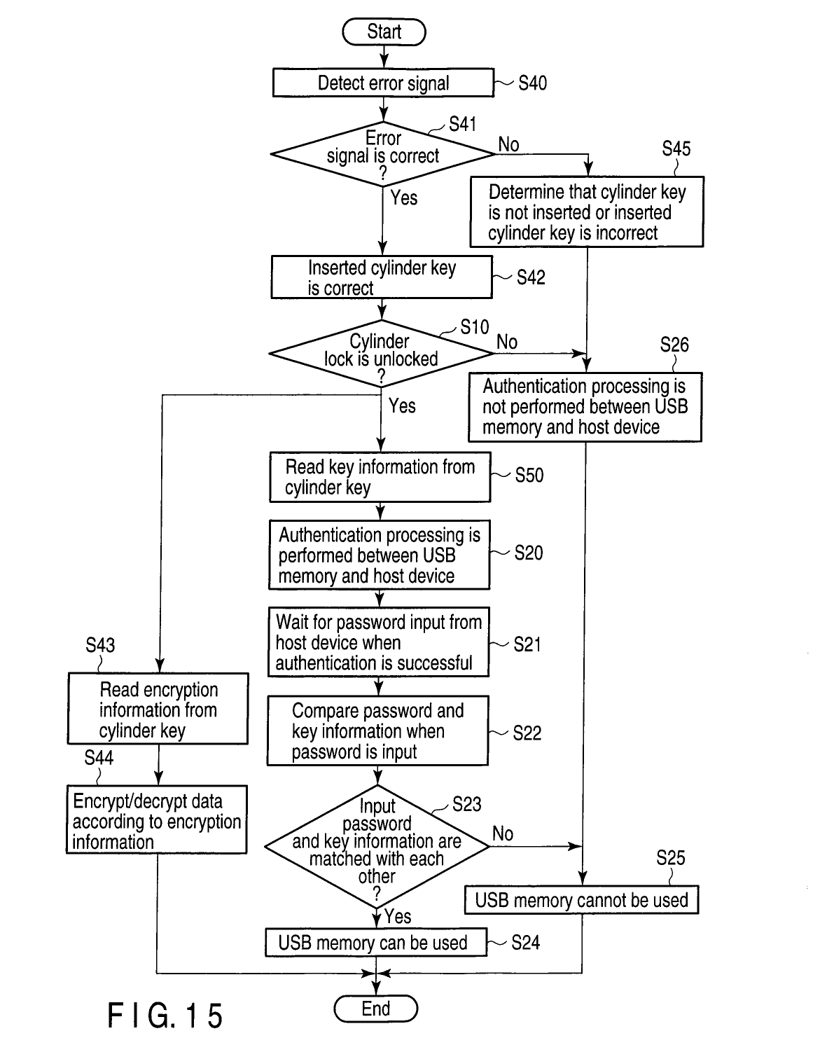

The fourth embodiment can be combined with the second embodiment. FIG. 15 illustrates the processing in the case in which the fourth embodiment is combined with the second embodiment. FIG. 15 is a flowchart illustrating the processing of the accepting unit 40.

As illustrated in FIG. 15, the MPU 22 disables the USB memory device 1, when the cylinder key 42 is not inserted or when the cylinder key 42 is unauthorized (NO in Step S41 and Step S45), or when the cylinder-lock is locked (NO in Step S10).

When the inserted cylinder key 42 is the correct key (YES in Step S41 and Step S42) and when the cylinder-lock is unlocked (YES in Step S10), the accepting unit 40 reads the key information from the cylinder key 42 (Step S50), and the MPU 22 performs the authentication processing in order to accept the input of the password (Step S20). When the input password is matched with the key information (YES in Step S23), the USB memory device 1 can be used. On the other hand, when the input password is not matched with the key information (NO in Step S23), the USB memory device 1 cannot be used.

When the cylinder-lock is unlocked (YES in Step S10), the encryption information is read (Step S43). The processing in Step S43 may be performed at the same time as the processing in Step S50 or after the processing in Step S42 or Step S24.

In the third modification, access to the USB memory device 1 is permitted only when the three conditions are satisfied. That is, the cylinder key 42 is correct, the cylinder-lock is unlocked, and the password input from the software is matched with the key information. Accordingly, the confidentiality of the data of the USB memory device 1 can further be improved.

In the third modification, any signal is used as the key information and the encryption information. For example, D[3:0] may be used as the key information while D[11:4] may be used as the encryption information. E[3:0] may be used not only as the error information but also the key information, while D[11:0] may be used as the encryption information. Thus, any bit of E[3:0] and D[11:0] can be used as the key information, and any one of the remaining bits can be used as the encryption information.

### Fifth Embodiment

A USB memory device according to a fifth embodiment will be described below. The fifth embodiment relates to an example of the physical key that can replace the cylinder key 42 therewith in the first to fourth embodiments.

### FIRST EXAMPLE

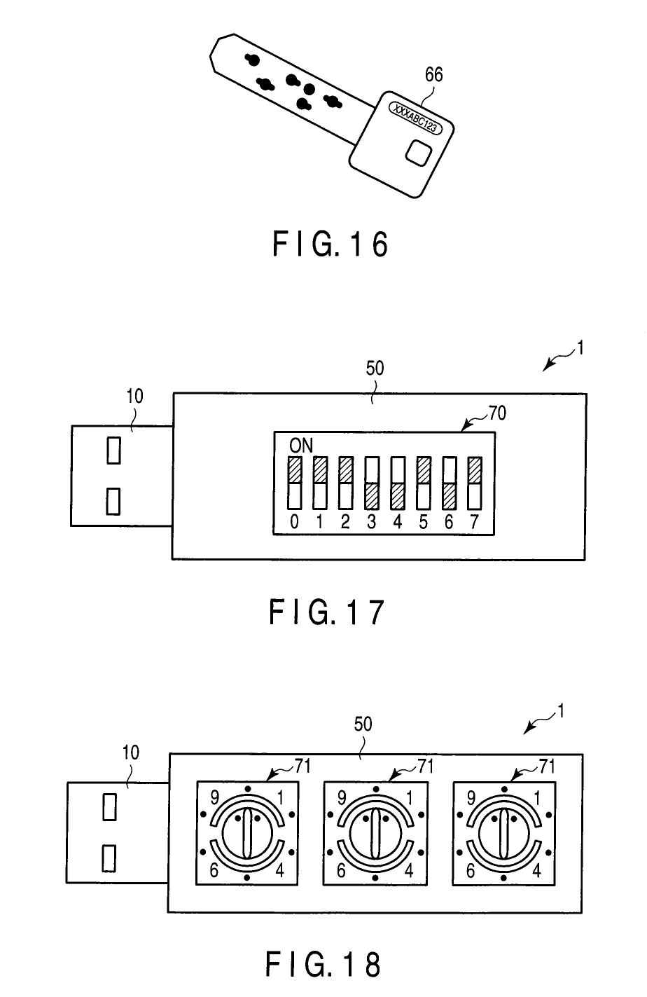

FIG. 16 illustrates a first example and is an appearance diagram of a dimple key. In the first to fourth embodiments, a dimple key 66 of FIG. 16 can be used instead of the cylinder key 42. When the dimple key 66 is used, the authentication is performed in a longitudinal direction and a crosswise direction due to the structure of the dimple key 66, the information amount (the number of bits) that is dealt with per one key is increased. Therefore, desirably the dimple key 66 is used from the standpoint of security.

### SECOND EXAMPLE

FIG. 17 is an appearance diagram of a USB memory device 1 according to a second example. As illustrated in FIG. 17, a DIP switch 70 may be used as the physical key instead of the cylinder-lock. At this point, a numerical value input from the DIP switch 70 can directly be used as the key information and/or the encryption information.

### THIRD EXAMPLE

FIG. 18 is an appearance diagram of a USB memory device 1 according to a third example. As illustrated in FIG. 18, a rotary switch 71 may be used as the physical key instead of the cylinder-lock. At this point, similarly a numerical value input from the rotary switch 71 can directly be used as the key information and/or the encryption information.

### FOURTH EXAMPLE

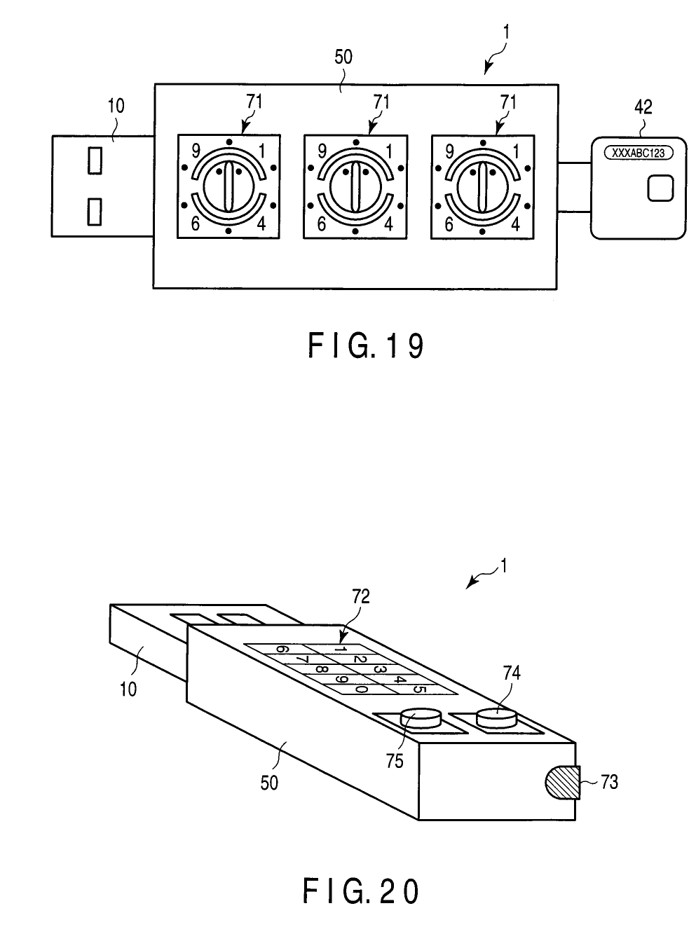

FIG. 19 is an appearance diagram of a USB memory device 1 according to a fourth example. As illustrated in FIG. 19, the rotary switch 71 and the cylinder-lock can be combined with each other. Obviously the DIP switch 70 of FIG. 17 and the cylinder-lock may be combined with each other.

### FIFTH EXAMPLE

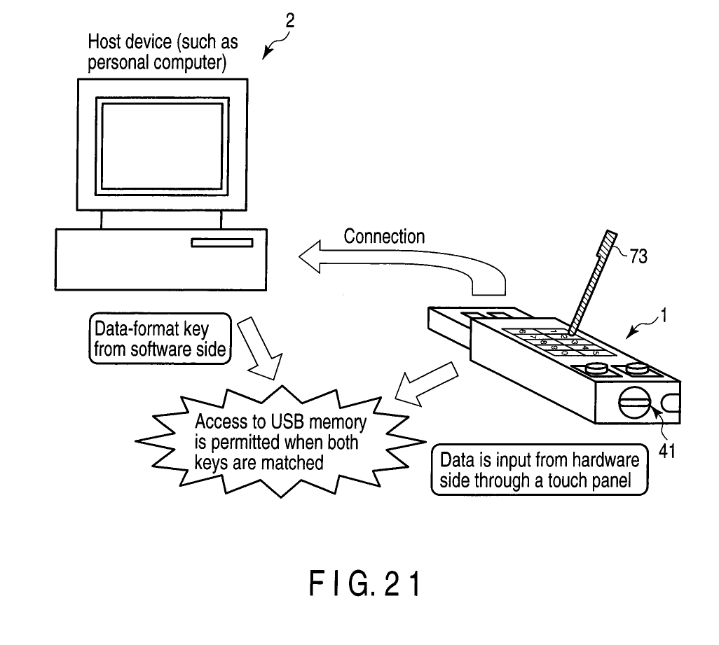

FIG. 20 is an appearance diagram of a USB memory device 1 according to a fifth example. FIG. 21 is a conceptual view illustrating an operation of the USB memory device 1 according to the fifth example. The fifth example relates to a method for electronically inputting the key information, unlike the first to fourth examples.

The USB memory device 1 of the fifth example includes a touch panel 72, a touch pen 73, an input determination button 75, and an input reset button 76. In the USB memory device 1, the input of the key information is accepted when the user touches the touch panel 73 using the touch pen 73. When the input of the key information is determined by the input determination button 75, the MPU 22 compares the input key information and the previously retained key information. The USB memory device 1 is unlocked when the input key information is matched with the previously retained key information. The input reset button 74 is used to reset the input key information.

Thus, the key with touch panel can also be used. In the fifth example, as illustrated in FIG. 21, the USB memory device 1 of the fifth example can be combined with the cylinder-lock 41. Further, access to the USB memory device 1 may be permitted when the key information input from the touch panel is matched with the password input from the host device.

### Sixth Embodiment

A USB memory device according to a sixth embodiment will be described below. The sixth embodiment relates to a method in which the locking function is used to restrict not the access to the whole of the USB memory device 1 but only part of the functions in the first to fifth embodiments. The USB memory device 1 has the same configuration as those of the first to fifth embodiments.

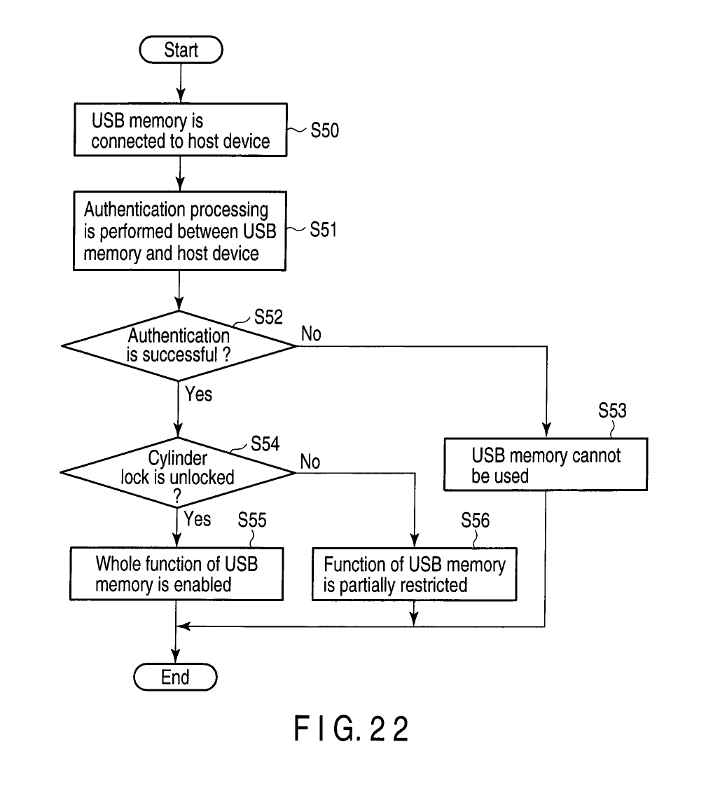

FIG. 22 is a flowchart illustrating the operation of the USB memory device 1 when the sixth embodiment is applied to the first embodiment by way of example.

As illustrated in FIG. 22, when the USB memory device 1 is connected to the host device (Step S50), the MPU 22 performs the authentication processing between the USB memory device 1 and the host device (Step S51). When the authentication is unsuccessful (NO in Step S52), the USB memory device 1 cannot be used (Step S53).

When the authentication is successful (YES in Step S52) and when the cylinder-lock is unlocked (YES in Step S54), all the functions of the USB memory device 1 are enabled (Step S55). On the other hand, when the cylinder-lock is locked (NO in Step S56), part of the functions of the USB memory device 1 are restricted (Step S56).

There is no particular limitation to the restricted functions. For example, at least one of the data writing, data reading, and data erasing may be prohibited. Access to one of the memory blocks BLK may be prohibited in the memory cell array 1. At this point, the MPU 22 prohibits the row decoder 33 from selecting the memory block BLK.

<Effect>

In the configuration of the sixth embodiment, only part of the functionality of the USB memory device 1 is restricted by the cylinder-lock, and any user can use the remaining functionality. Therefore, the usability can be improved while the high confidentiality of the USB memory device 1 is maintained.

In FIG. 22, the sixth embodiment is applied to the first embodiment. When the sixth embodiment is applied to the second embodiment, after the determination that the cylinder-lock is unlocked is made in Step S54, Steps S21 and S22 of FIG. 8 are performed, and the flow goes to Step S55 when the password is matched with the key information (YES in Step S23), or the flow goes to Step S56 when the password is not matched with the key information (NO in Step S23).

When the sixth embodiment is applied to FIG. 14 of the fourth embodiment, the processing from Step S50 of FIG. 22 can be performed after the processing in Step S42. When the sixth embodiment is applied to FIG. 15, after the processing in Step S42, Steps S51 and S52 of FIG. 22 are performed, the flow goes to the processing in Step S10 of FIG. 15, and the flow goes to Step S55 when the password is matched with the key information (YES in Step S23) or the flow goes to Step S56 when the password is not matched with the key information (NO in Step S23).

Obviously, in the sixth embodiment, the dimple key 66 of FIG. 16 can be used instead of the cylinder key 42. The keys of FIG. 17 to FIG. 20 can be used instead of the cylinder-lock.

As described above, the USB memory device 1 of the first to sixth embodiments includes the cylinder-lock 40, the storage unit 30 which is capable of storing data, and the control unit 20 which prohibits at least part of the access to the storage unit 30 from the outside when the USB memory device is locked by the cylinder-lock 40.

The USB memory device 1 includes the accepting unit 40 which accepts the locking/unlocking command using the physical mechanism, the storage unit 30 which is capable of storing data, and the control unit 20 which permits at least part of the access to the storage unit 30 from the outside when the command is matched with the password input from the outside.

The above-described configuration can provide a USB memory device that can retain the confidentiality of the data while suppressing the degradation of the usability.

Although the USB memory device is described by way of example in the embodiments, the embodiments can be applied to other external storage media. The semiconductor memory embedded to the external storage medium is not limited to the NAND flash memory, and the semiconductor memory may be other semiconductor memories such as a NOR flash memory, a Magneto-resistive Random Access Memory (MRAM), or a ferroelectric memory device. The embodiments are not limited to the semiconductor memory, and the embodiments may be applied to other storage devices such as a portable hard disk drive.

The key information and encryption information, which are obtained from cylinder key 42 or the like and the password input from the host device may be set in units of files recorded in the NAND flash memory 30. That is, in order to access a first file (or file group), the cylinder-lock is unlocked with the first key (for example, cylinder key 42-1), and the encryption method based on the first file or a first password is used. In order to access a second file (or file group), the cylinder-lock is unlocked with a second key (for example, cylinder key 42-2), and the encryption method based on the second file or a second password is used. When the DIP switch 70, the rotary switch 71, or the touch panel-format key is used, the numerical values input from the DIP switch 70, rotary switch 71, or touch panel-format key may individually be set in each file that becomes the access target.

In the fifth embodiment, some examples are described as the physical lock in addition to the cylinder-lock. However, there is no limitation to the physical lock as long as the physical lock is locked/unlocked by a physical mechanism. The method for reading the key information and the encryption information from the key shape is not limited to the second to third embodiments, and various methods can be selected as the method for reading the key information and the encryption information from the key shape. A sensor such as a photo interrupter may be used in the optical technique of the fourth embodiment.

When the DIP switch 70 or the rotary switch 71 is used as the physical lock, the MPU 22 compares the key information input from the switch 70 or 71 to the password retained by, for example, the ROM 23, the RAM 24, or the NAND flash memory 30, and the MPU 22 unlocks the physical lock when the key information is matched with the password. That is, this case corresponds to “the cylinder-lock is unlocked (YES in Step S10)” in Step S10 of the first to fourth embodiments.

This can also be applied to the case in which the cylinder key 42 or the dimple key 66 is used. That is, the MPU 22 may compare the key information read from the key 42 or 66 with the internally retained password. This case corresponds to “the cylinder-lock is unlocked (YES in Step S10)” when the cylinder-lock is unlocked and when the key information is matched with the password. Additionally, the password input from the host device may further be compared to the key information.

For the structure in which the key is twisted to rotate the inner cylinder of the cylinder 41 using the cylinder-lock, it is necessary that a thickness of the package 50 be larger than a diameter (the key tooth portion of the key) of the cylinder 41, and the cylinder 41 may have a cylindrical shape or a pin shape.

However, even if the cylinder-lock is used, the thickness of the package 50 can be decreased by adopting a configuration in which the twist of the key is not required. That is, instead of twisting the key, the locking/unlocking may be determined by the presence or absence of the key insertion. For example, the determination that the cylinder-lock is unlocked may be made when the key is inserted to align the tumblers 44 with the shear line. Alternatively, the determination that the cylinder-lock is unlocked may be made when the key information on the inserted key is matched with the password retained in the USB memory device 1, and/or the USB memory device 1 may be enabled when the key information is matched with the password input from the host device.

The password retained by the ROM 23, the RAM 24, or the NAND flash memory 30 can be set by various methods. For example, when the DIP switch 70 or the rotary switch 71 is used, the password may be changeable using the switch 70 or 71 and dedicated management software. Even in the cylinder-lock, the password may be changeable by selecting one of plural passkeys. When the user forgets the password, the USB memory device 1 is formatted to erase all the recorded contents, which allows the reset of the password.

In the embodiments, the operation is described using various flowcharts. However, the flowchart is illustrated only by way of example. The processing steps can be replaced to the extent possible, plural processing steps can simultaneously be performed, and possibly some processing steps may be eliminated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A USB memory device comprising:
a cylinder-lock;
a storage unit which is capable of storing data; and
a control unit which prohibits at least a part of access to the storage unit from an outside when the cylinder-lock is locked.

2. The device according to claim 1, wherein the control unit permits at least part of access to the storage unit from the outside when information on a key inserted in the cylinder-lock is matched with a password input from the outside.

3. The device according to claim 2, wherein the information corresponds to a shape of a key tooth of the key.

4. The device according to claim 2, wherein the cylinder-lock includes a light emitting unit and a light receiving unit which receives light emitted from the light emitting unit, and
the information is provided based on whether the light emitted by the light emitting unit is blocked by the key.

5. The device according to claim 4, wherein the key inserted includes an opening through which the light is passed, the opening being located in a position corresponding to the light emitting unit and the light receiving unit.

6. The device according to claim 1, wherein the control unit determines an encryption method according to a key inserted in the cylinder-lock, encrypts the data according to the determined encryption method, and stores the encrypted data in the storage unit.

7. The device according to claim 6, wherein the control unit determines the encryption method according to a shape of a key tooth of the key.

8. The device according to claim 6, wherein the cylinder-lock includes a light emitting unit and a light receiving unit which receives light emitted from the light emitting unit, and
the control unit determines the encryption method based on whether the light emitted by the light emitting unit is blocked by the key.

9. The device according to claim 8, wherein the key includes an opening through which the light is passed, the opening being located in a position corresponding to the light emitting unit and the light receiving unit.

10. The device according to claim 6, wherein the cylinder-lock includes a light emitting unit and a light receiving unit which receives light emitted from the light emitting unit, and
the control unit retains first information,
the control unit obtains second information based on whether the light emitted by the light emitting unit is blocked by the key, and
the control unit encrypts the data when the second information is matched with the first information, and the control unit does not encrypt the data when the second information is not matched with the first information.

11. The device according to claim 1, wherein the cylinder-lock includes a light emitting unit and a light receiving unit which receives light emitted from the light emitting unit, and
the control unit retains first information,
the control unit obtains second information based on whether the light emitted by the light emitting unit is blocked by a key inserted in the cylinder-lock,
the control unit performs authentication processing between the USB memory device and a host device, when the cylinder-lock is unlocked and when the second information is matched with the first information, and
the control unit does not perform the authentication processing when the cylinder-lock is locked or when the second information is not matched with the first information.

12. A USB memory device comprising:
an accepting unit which accepts a locking/unlocking command using a physical mechanism;
a storage unit which is capable of storing data; and
a control unit which permits at least part of access to the storage unit from an outside when the command is matched with a password input from the outside.

13. The device according to claim 12, wherein the physical mechanism is a locking mechanism which is unlocked by a key inserted from the outside, and
the command is information based on a shape of the key.

14. The device according to claim 13, wherein the locking mechanism includes a light emitting unit and a light receiving unit which receives light emitted from the light emitting unit, and
the command is provided based on whether the light emitted by the light emitting unit is blocked by the key.

15. The device according to claim 14, wherein the key includes an opening through which the light is passed, the opening being located in a position corresponding to the light emitting unit and the light receiving unit.

16. The device according to claim 12, wherein the control unit determines an encryption method according to the command, encrypts the data according to the determined encryption method, and stores the encrypted data in the storage unit.

17. The device according to claim 16, wherein the physical mechanism is a locking mechanism which is unlocked by a key inserted from the outside,
the locking mechanism includes a light emitting unit and a light receiving unit which receives light emitted from the light emitting unit, and
the control unit determines the encryption method based on whether the light emitted by the light emitting unit is blocked by the key.

18. The device according to claim 16, wherein the physical mechanism is a locking mechanism which is unlocked by a key inserted from the outside,
the locking mechanism includes a light emitting unit and a light receiving unit which receives light emitted from the light emitting unit,
the control unit retains first information,
the control unit obtains second information based on whether the light emitted by the light emitting unit is blocked by the key, and
the control unit encrypts the data when the second information is matched with the first information, and the control unit does not encrypt the data when the second information is not matched with the first information.

19. The device according to claim 12, wherein the physical mechanism is one of a DIP switch, a rotary switch, and a mechanism which unlocks/locks by accepting input of key information from the outside.
